(19) United States
(12) Patent Application Publication
(10) Pub. No.: US 2022/0104648 A1
(43) Pub. Date: Apr. 7, 2022

(54) TREETOP SUPPORT

(71) Applicant: Ningbo Tree Nest International Trading Co.,Ltd., Ningbo (CN)

(72) Inventor: Honghua Zhao, Ningbo (CN)

(21) Appl. No.: 17/450,831

(22) Filed: Oct. 13, 2021

(30) Foreign Application Priority Data
Jul. 30, 2021 (CN) 202121769010.3

(51) Int. Cl. A47G 33/10; F16B 2/04

(52) U.S. Cl. CPC A47G 33/10; F16B 2/04

(57) ABSTRACT

The present disclosure relates to the technical field of festival decoration products, and in particular, relates to a treetop support. The treetop support includes a support body, a support assembly, and an adjustment assembly. The support assembly includes a plurality of support members pivotably fitted on a support rod. Support surfaces of the support members are collectively formed as a support plane. The adjustment assembly is displaceably arranged along an extending direction of the support body. The adjustment assembly is fitted on a lower end or an inner wall of each of the support members, such that the support member is pivoted with respect to the support rod to adjust an angle of the support surface.

### TECHNICAL FIELD

The present disclosure relates to the technical field of festival decoration products, and in particular, relates to a treetop support configured to fix a treetop decorative piece to a treetop of a Christmas tree.

### BACKGROUND

Christmas trees are commonly used for festival decoration and ornament, and generally, various decorative pieces or ornaments, for example, color lights, color strips, and the like, may also be put on the Christmas tree. Treetop decorative pieces are also commonly used for the Christmas tree. Conventionally, treetops of the Christmas trees have substantially consistent shape and dimension (some differences may be present in terms of dimension between real trees and artificial trees). However, the treetop decorative pieces have different fixing bases depending on different designs and styles.

Typically, a dedicated fixing support is correspondingly arranged according to the specific shape of a treetop decorative piece to fix the decorative piece to the treetop of the Christmas tree. However, the conventional fixing support fails to particularly match with all types of treetop decorative pieces, or achieves a poor fixing effect even the fixing support is capable of fixing the treetop decorative pieces.

Therefore, it is necessary to develop a novel treetop support capable of matching with most of the treetop decorative pieces and achieving a good fixing and support effect.

### SUMMARY

With respect to a convention treetop decorative piece, a connection portion configured to fix the treetop decorative piece to a Christmas tree is typically a conical structure, a cylindrical structure, a straight-rod structure, a clamp structure, a baby skirt internal support structure, or the like structure. In this case, a dedicated fixing portion is generally desired, or the connection portion merely adapts to a Christmas tree having a particular treetop structure. The present disclosure is intended to provide a treetop support applicable to a treetop of a Christmas tree to fix treetop decorative pieces of different shapes or dimensions to the treetop of the Christmas tree.

In some embodiments, a treetop support is provided. The treetop support is applicable to a treetop of a Christmas tree to allow a treetop decorative piece to be fixed to the treetop of the Christmas tree by the treetop support. The treetop support includes a support body, and a support assembly and an adjustment assembly that are fitted on the support body; wherein

the support body includes a support rod, and the support assembly includes at least two support members, an upper end of each of the support members being pivotally fitted on an upper end of the support rod, an outer surface of each of the support members being formed as a support surface, the support surfaces being collectively formed as a cylindrical support surface or a prismatic surface of the support assembly; and

the adjustment assembly is displaceably arranged along an extending direction of the support rod, and the adjustment assembly includes an adjustment portion, the adjustment portion being fitted on a lower end or an inner wall of each of the support members.

In some other embodiments, a treetop support is provided. The treetop support is applicable to a treetop of a Christmas tree to allow a treetop decorative piece to be fixed to the treetop of the Christmas tree by the treetop support. The treetop support includes a support body, and a support assembly and an adjustment assembly that are fitted on the support body; wherein

the support assembly includes a plurality of support members, each of the support members being pivotably fitted on the support body, an outer surface of each of the support members being formed as a support surface; and

the adjustment assembly is displaceably arranged along an extending direction of the support body, and the adjustment assembly is fitted on a lower end or an inner wall of each of the support members.

In some other embodiments, a treetop support is provided. The treetop support is applicable to a treetop of a Christmas tree to allow a treetop decorative piece to be fixed to the treetop of the Christmas tree by the treetop support. The treetop support includes a support body, and a support assembly and an adjustment assembly that are fitted on the support body; wherein

the support assembly includes a plurality of support members, each of the support members being pivotably fitted on the support body, an outer surface of each of the support members (210) being formed as a support surface; and the adjustment assembly is displaceably arranged along an extending direction of the support body, and the adjustment assembly (300) is fitted on a lower end or an inner wall of each of the support members; and

the treetop support further includes a first rod, a second rod, and a connection member, an upper end of the first rod being fitted with the lower cavity, a lower end of the first rod and an upper end of the second rod being respectively fitted with an upper end and a lower end of the connection member.

With the treetop support according to the present disclosure, by the displacement of the adjustment assembly along the support rod, each of the support members of the support assembly is pivoted to a desired angle with respect to the support rod, such that a conical or cone-like support plane may be formed on the outer surface of the support member. In addition, the angle of the support plane may be adjusted according to the actual needs to adapt to treetop decorative pieces having fixing connection portions with different angles of conical surface.

In addition, when each of the support members is in a folding state where the support member is not pivoted, the support member is arranged to be attached to the support body. The treetop support may be in a cylindrical shape, a prismatic shape, a conical shape, a truncated cone shape, or the like. In this case, in one aspect, the treetop support has a small volume in a folding state, and in another aspect, the treetop support may match with the treetop decorative piece having a fixing connection portion with a fixing inner cavity in a cylindrical shape, a prismatic shape, or the like shape, such that the treetop decorative piece is fixed to the treetop of the Christmas tree.

### BRIEF DESCRIPTION OF THE DRAWINGS

FIG. 1 is a schematic perspective structural view of a treetop support according to an embodiment of the present disclosure;

FIG. 2 is a sectional view of the treetop support according to the embodiments as illustrated in FIG. 1;

FIG. 3 is a schematic exploded structural view of the treetop support according to the embodiment as illustrated in FIG. 1;

FIG. 4 is a schematic partial enlarged view of FIG. 3;

FIG. 5 is a schematic structural view of an adjustment assembly 300 according to the embodiments as illustrated in FIG. 1;

FIG. 6 is a schematic structural view of the treetop support in an initial open state according to the embodiment as illustrated in FIG. 1;

FIG. 7 is a sectional view of FIG. 6, wherein two partial enlarged views are included;

FIG. 8 is a schematic structural view of the treetop support in an open and use state according to the embodiment as illustrated in FIG. 1;

FIG. 9 is a schematic perspective structural view of a treetop support according to another embodiment of the present disclosure;

FIG. 10 is a sectional view of the treetop support as illustrated in FIG. 9;

FIG. 11 is a schematic exploded view of a treetop support according to another embodiment of the present disclosure, wherein the adjustment assembly is locked and positioned by fitting between a locking block and a locking slot;

FIG. 12 is a schematic structural view of the support rod according to the embodiment illustrated in FIG. 11;

FIG. 13 is a schematic view illustrating fitting between the treetop support and a treetop decorative piece having a conical fixing portion according to the present disclosure;

FIG. 14 is a schematic view illustrating fitting between the treetop support and a baby-shaped treetop decorative piece according to the present disclosure;

FIG. 15 is a schematic view illustrating fitting between the treetop support and a treetop decorative piece having a cylindrical fixing portion according to the present disclosure;

FIG. 16 is a schematic view illustrating fitting between the treetop support and a treetop decorative piece having a clamp as a fixing portion according to the present disclosure;

FIG. 17 is a schematic view illustrating fitting between the treetop support and a treetop decorative piece having a rod-like fixing portion according to the present disclosure;

FIG. 18 is a schematic view illustrating fitting between the treetop support and a particular-shape treetop decorative piece according to the present disclosure;

FIG. 19 is a schematic structural view of a treetop support according to another embodiment of the present disclosure, wherein the treetop support includes additional three parts which are formed as an integral structure, and during use, one or more of the parts may be selected correspondingly according to the actual needs as the tree-top support for fixing the treetop decorative piece to a treetop of a Christmas tree; and

FIG. 20 is a schematic structural view of a treetop support fitted on a treetop of a Christmas tree according to an embodiment of the present disclosure, wherein the treetop support is fixed to the treetop of the Christmas tree by a strap 404 arranged at a strap fixing port 403 such that the treetop support is fixed to the treetop of the Christmas tree.

In the above perspective views, sectional lines are merely intended to differentiate adjacent parts, instead of representing materials of the parts.

### DETAILED DESCRIPTION

For better understanding of the present disclosure by a person skilled in the art and for more clear definition of the protection scope of the present disclosure, the present disclosure is described hereinafter in detail with reference to some specific embodiments. It should be noted that the specific embodiments construed for the present disclosure are only illustrated, which are merely a part of embodiments of the present disclosure. The specific and direct descriptions of the related structures are only for ease of understanding of the present disclosure, and various specific features are not intended to directly limit the practice of the present disclosure. Any customary selections and replacements made by a person skilled in the art under the concept of the present disclosure shall all be considered as falling within the protection scope of the present disclosure.

A treetop support is provided. The treetop support is applicable to a treetop of a Christmas tree to allow a treetop decorative piece to be fixed to the treetop of the Christmas tree by the treetop support. In this way, an object of decorating the Christmas tree is achieved.

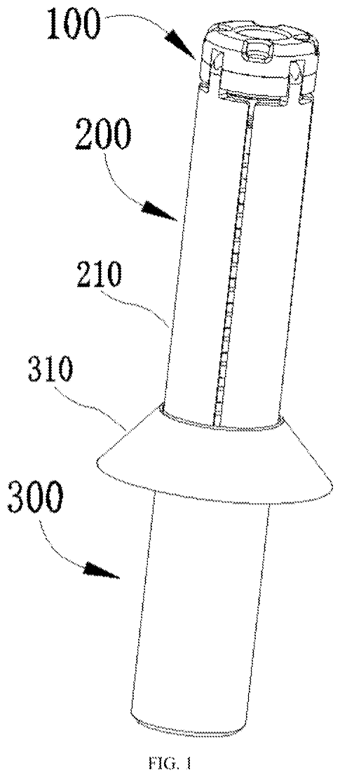

Referring to FIG. 1 to FIG. 3, the treetop support includes a support body 100, and a support assembly 200 and an adjustment assembly 300 that are fitted on the support body. The support body 100 is configured to be fitted with a treetop of a Christmas tree to fit the treetop support assembly to the treetop of the Christmas tree. The support assembly 200 and the adjustment assembly 300 are both fitted on the support body 100. The support assembly 200 is pivoted to present different fitting states such that different treetop decorative pieces are fixed to the treetop of the Christmas tree by the treetop support. The adjustment assembly 300 is displaceably fitted on the support body 100 to adjust a fitting state of the support assembly 200 with respect to the support body 100.

The support body 100 includes a support rod 110. The support rod 110 is in a rod or rod-like structure to achieve a critical support function.

The support assembly 200 includes a plurality of support members 210. Each of the support members 210 is pivotably fitted on the support rod 110. An outer surface of each of the support members 210 is formed as a support surface 211. The support surfaces 211 form different angles with the support rod 110 due to pivoting of the support members 210. The support surfaces 211 of the support members 210 collectively formed as a support plane of the support assembly 200, such that the treetop decorative piece is fitted on the support plane. In addition, since a pivoting angle of each of the support members 210 with respect to the support rod 110 are adjustable, an angle of the support plane formed by the support surfaces 211 is also adjustable. In this way, the treetop support may adapt to treetop decorative pieces in different shapes and dimensions.

The adjustment assembly 300 is displaceably arranged along an extending direction of the support rod 110. The adjustment assembly 300 includes an adjustment portion 310. When the adjustment assembly 300 is displaced along the support rod 110, the adjustment portion 310 is synchronously displaced correspondingly. In addition, the adjustment portion 310 is fitted on a bottom or an inner wall of each of the support members 210, such that the support member 210 is pivoted with respect to the support rod 110, and the angle between the support member 210 and the support rod 110 is also correspondingly increased or decreased. In this way, different conical support structures with different dimensions are formed to adapt to the treetop support having a conical or cone-like fixing connection portion. In addition, the support members 210 may also be such pivoted that each of the support members 210 is attached to the support rod 110 to form a support structure in a cylindrical shape or a prismatic shape such that the treetop support is folded and received, or may serve as a treetop support matching with a fixing connection portion in a cylindrical shape or with an clamp acting as a fixing connection portion.

When the treetop support adapts to a treetop decorative having different fixing connection portions, fitting between the treetop support and the treetop decorative piece is as follows.

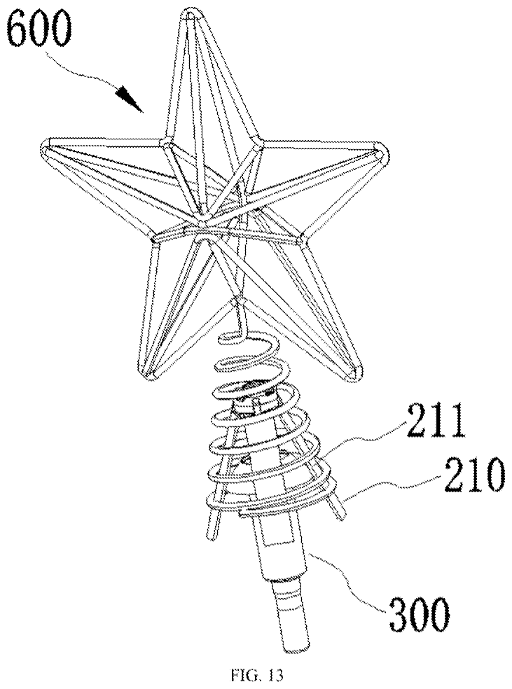

Referring to FIG. 8, each of the support member 210 of the treetop support is pivoted by a suitable angle to form a cone-like support plane formed by four support members 210, and the adjustment assembly 300 is rotated by a threaded structure with respect to the support rod 110, and displaced to a suitable position and maintained at the position. In this case, an inner wall of each of the support members 210 is supported by the adjustment portion 310 of the adjustment assembly 300. Still referring to FIG. 13, a treetop decorative piece 600 is provided with a conical fixing portion formed by spiraling of a linear portion, which is sleeved on a conical support surface of the treetop support member. Apparently, the treetop support is displaceable upward and downward along the support rod 110 by the adjustment assembly 300, such that the support members 210 exhibits different angles of conical surfaces, and thus the treetop support adapts to various conical fixing portions having different angles of conical surfaces.

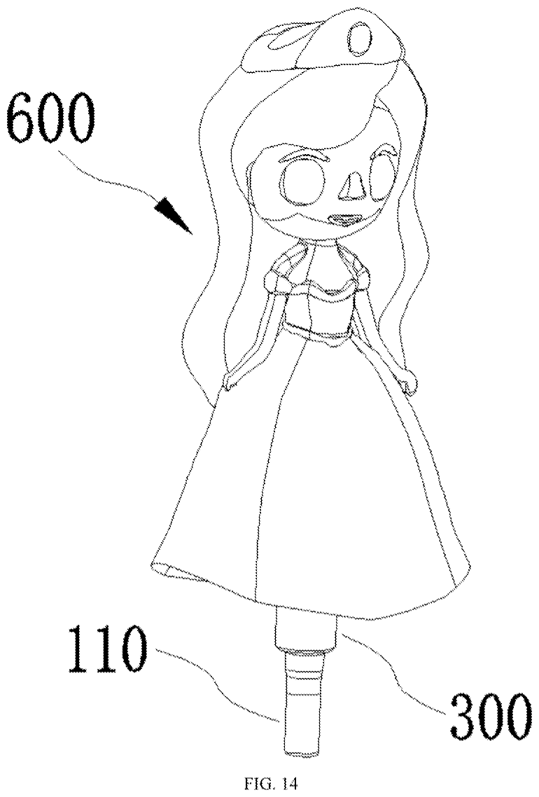

Referring to FIG. 14, by adjustment of the angles of conical surfaces, the treetop support may also be caused to adapt to inside of the skirt of a baby-shaped treetop support, such that the baby-shaped treetop support is fixed.

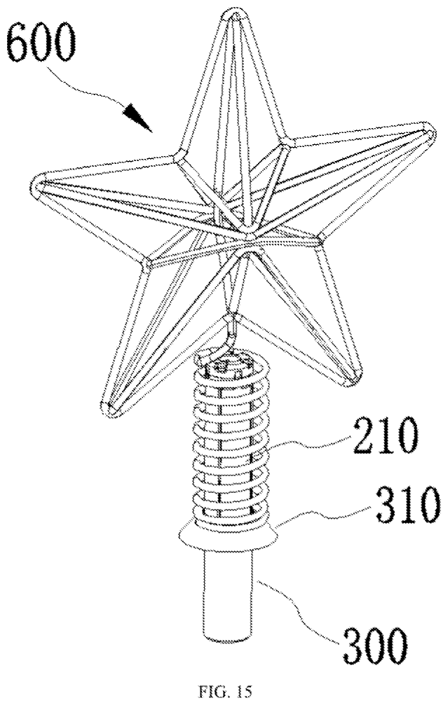

Referring to FIG. 15, when the support members 210 are in a folding and receiving state, the treetop support is formed to have a cylindrical upper structure. In this way, not only a folding state of the treetop support may be formed, but also a treetop decorative piece having a fixing connection portion with a cylindrical fixing inner cavity is fixed. In this case, the fixing connection portion having the cylindrical fixing inner cavity of the treetop decorative piece has an inner diameter greater than or equal to an outer diameter of each of the support members 210, and a lower end of the fixing connection portion is supported by the adjustment portion 310, such that the treetop decorative piece 600 is fixed.

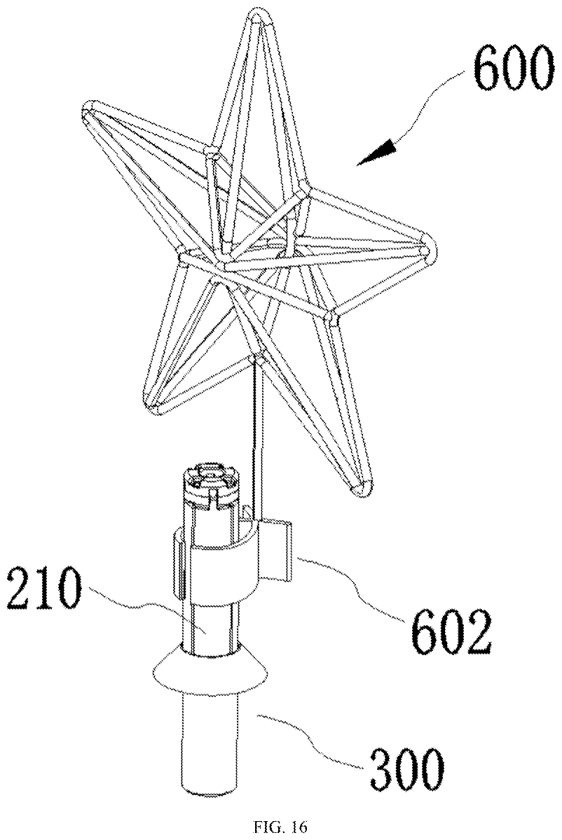

Referring to FIG. 16, likewise, when the support members 210 are in the folding and receiving state, the treetop support may also employ a clamp as the fixing connection portion to fix the treetop decorative piece. In this case, the fixing connection portion of the treetop decorative piece 600 is a clamp 602. One end of the clamp is clamped onto the support members 210 in the folding and receiving state to fix the treetop decorative piece 600.

Therefore, based on different states formed by pivoting of the support members 210 with respect to the support rod 110, the treetop support may match with the treetop decorative piece 600 fixed by a variety of configurations such as a fixing connection portion with a conical inner cavity, a skirt fixing connection portion, a fixing connection portion with a cylindrical inner cavity, and a clamp fixing connection portion.

In some embodiments, an end of the support member 210 is provided with a pivot shaft 201, the support rod 110 is correspondingly provided with a shaft base. The pivot shaft 201 is fitted into the shaft base, such that the support member 210 is pivotably arranged with a position at an upper end thereof as a pivot shaft.

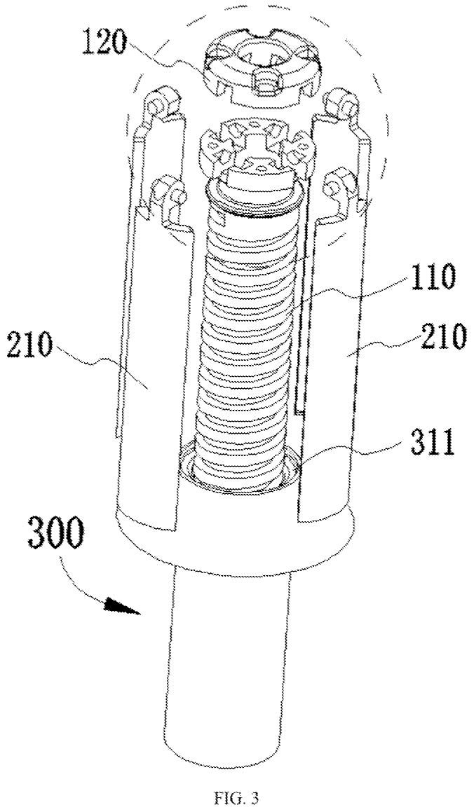

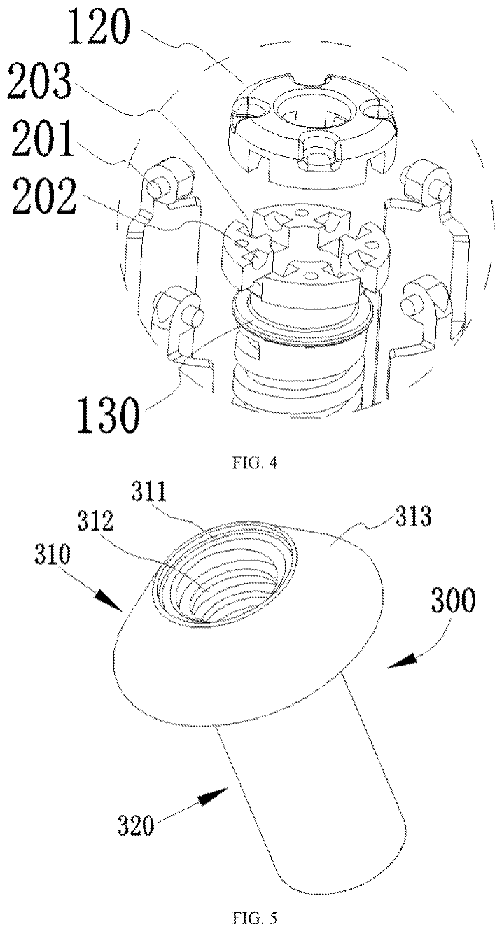

Referring to FIG. 3 and FIG. 4, a top pf the support rod 110 is provided with a shaft base fixing cover 120. The shaft base fixing cover 120 is fixed to the support rod 110 by a screw (not shown in the drawings). The shaft base fixing cover 120 and the support rod 110 are each provided with a half shaft base 202, and the two half shaft bases 202 respectively arranged on the shaft cover fixing cover 120 and the support rod 110 cooperate with each other and form the shaft base after the shaft base fixing cover 120 and the support rod 110 are fixed to each other.

The top of the support rod 110 is further provided with a pivot hole 203, such that an upper portion of each of the support members 210 is fitted into the pivot hole 203, such that each of the support members 210 is pivotably fitted on the support rod 110 about the pivot shaft 201.

Although the shaft base fixing cover 120 and the support rod 110 are fixed by the screw as illustrated in FIG. 5, other known connection techniques may also be employed, for example, snap-fitting, adhesive-bonding, or the like.

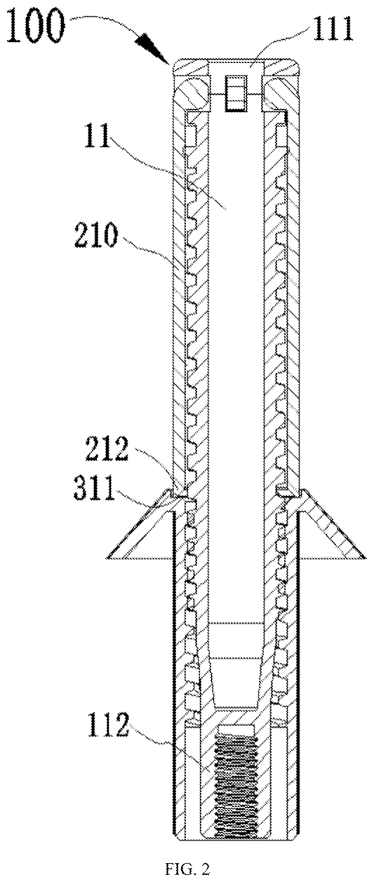

Referring to FIG. 2 and FIG. 5, to lock each of the support members 210 when not being used, an upper end surface of the adjustment portion 310 is provided with a locking slot 311. A lower end 212 of each of the support member 210 is fittable into the locking slot 311, such that the treetop support may be formed as a relatively fixed integral structure when not being used. That is, when each of the support members 210 is pivoted to be attached to the support rod 110 to form a cylindrical shape, the lower end 212 of each of the support members 210 is locked into the locking slot 311, such that each of the support members 210 fails to be freely pivoted.

Referring to FIG. 5, to enable each of the support members 210 to be automatically pivoted to a desired angle during adjustment of the treetop support, the adjustment portion 310 is provided with a guide surface 313. The guide surface 313 is a conical surface or a curved surface, and outwardly acts on the lower end 212 of the support member 210 to achieve a guide effect. When the adjustment assembly 300 is displaced along the support rod 110, for example, displaced from bottom to top, the lower end of the support member 210 is slided along the guide surface 313 and is automatically unfolded by the guide effect.

In addition, it is also feasible that the adjustment portion 310 is not provided with the guide surface 313, as long as the treetop support is inverted during initial adjustment or each of the support members 210 is manually driven. In this case, an upper surface of the adjustment portion 310 is designed as a flat surface.

Referring to FIG. 5, for ease of operation of the adjustment assembly 300, the adjustment assembly 300 further includes a hand-wheel portion 320, which is arranged under the adjustment portion 310. In addition, to enable the adjustment assembly 300 to be displaceably arranged with respect to the extending direction of the support rod 110, the adjustment assembly 300 is hollowed out and formed as a cylindrical cavity 312. The cylindrical cavity 312 is sleeved on the outside of the support rod 110, such that the adjustment assembly 300 is displaceable upward and downward along the support rod 110.

In some embodiments, an outer wall of the support rod 110 and an inner wall of the cylindrical cavity 312 are respectively provided with threaded structures fittable with each other, such that the adjustment assembly 300 is displaced upward and downward or positioned by rotation with respect to the support rod 110. Specific parameters (for example, a pitch) of the threaded structures may be defined according to the actual needs, such that the adjustment assembly 300 achieves a suitable displacement distance in response to being rotated by 360 degrees, and is positioned at a corresponding position.

In some other embodiments, upward and downward displacement or positioning is achieved between the support rod 110 and the adjustment assembly 300 by thread engagement, and thus another equivalent alternative structure is achieved.

For example, the adjustment assembly 300 is freely displaceably sleeved on the support rod 110 and is locked and positioned by a locking mechanism, wherein the locking mechanism includes a locking slot 113 and a locking block (not shown in the drawings) respectively arranged on the support rod 110 and the adjustment assembly 300. When the locking block and the locking slot 113 are separated from each other for unlocking, the adjustment assembly 300 is capable of being freely displaced to a desired position along the extending direction of the support rod 110, such that the locking block is fitted into the locking slot 113 to lock the displacement of the adjustment assembly 300 along the support rod 110, and thus the adjustment assembly 300 is positioned. In this way, each of the support members 210 exhibits a desired angle of conical surface.

The locking slot is preferably arranged on an outer surface of the support rod 110 along the extending direction of the support rod 110. The adjustment assembly 300 is correspondingly provided with a locking block. When the locking block is fitted into the locking slot, the adjustment assembly 300 is displaced with respect to the support rod 110 along the extending direction of the support rod 110 and thus is locked and positioned. If the adjustment assembly 300 needs to be operated to be displaced with respect to the support rod 110, the locking block needs to be operated to be separated from the locking slot. When the adjustment assembly is displaced to a suitable position, the locking block and the locking slot are fitted with each other again to achieve locking again. The structure of the locking block is known, for example, by arranging an elastic member on an inner wall of the cylindrical cavity 312 at one end and forming a locking block fittable into the locking slot at the other end.

In addition, when the adjustment assembly 300 is freely displaceable sleeved on the support rod 110 and is locked and positioned by the locking mechanism, the outer wall of the support rod 110 may also be further fitted with an inner wall 314 of the cylindrical cavity by friction. Specifically, by interference fitting between inner and outer diameters or an elastic piece mating structure, the adjustment assembly 300 is displaced or positioned along the extending direction of the support rod 110. Nevertheless, when the friction between the outer wall and the inner wall is sufficiently great, the locking mechanism constituted by the locking slot and the locking block may be omitted.

Although the guide surface 313 is capable of causing each of the support members 210 to be automatically pivoted to a desired angle under the guide effect thereof, the guide effect is not effected during initial operations in a locking state. Further simplification of the operations and improvement of user experience, the treetop support further includes an unlocking assisting member 130, which acts on each of the support members 210 at an initial state of unlocking, such that the support member 210 is pivoted to a desired angle, and thus the lower end of the support member 210 is unfolded and fitted with the guide face 313.

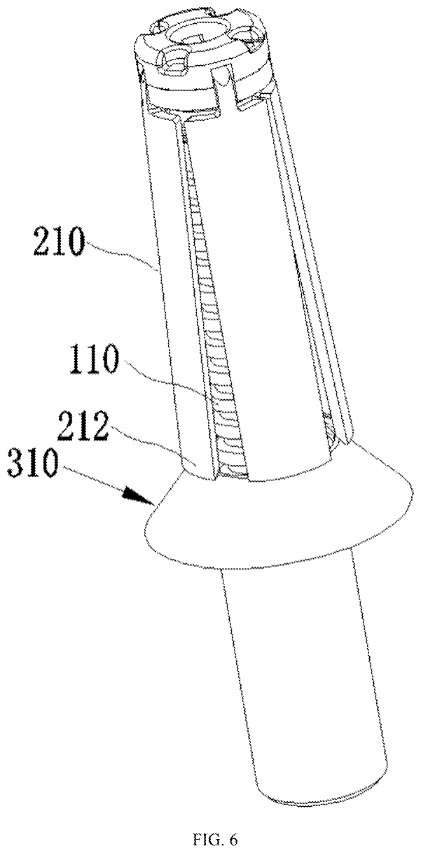

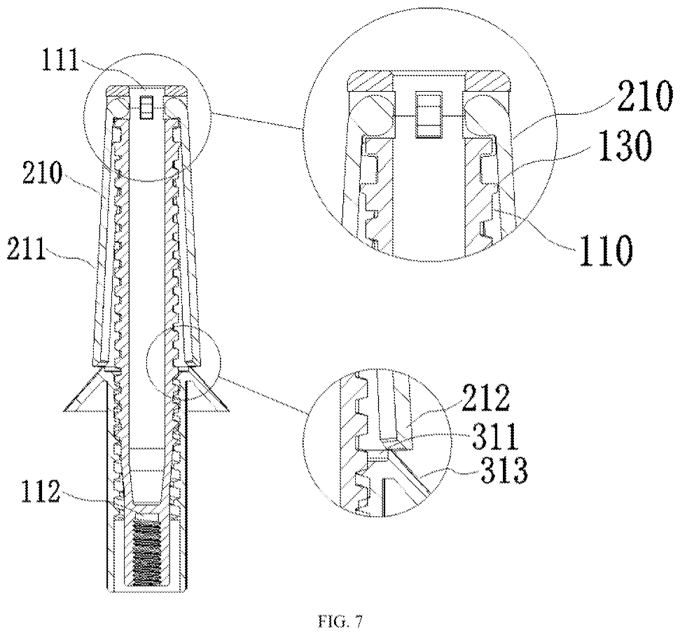

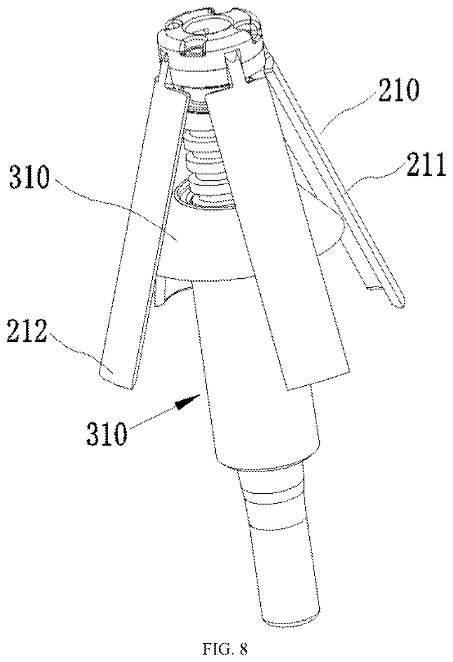

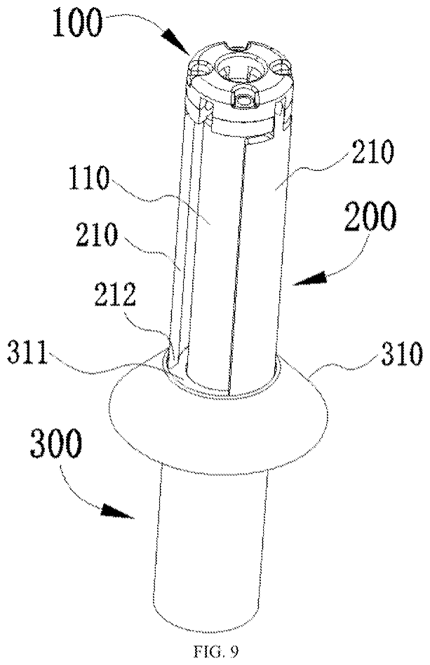

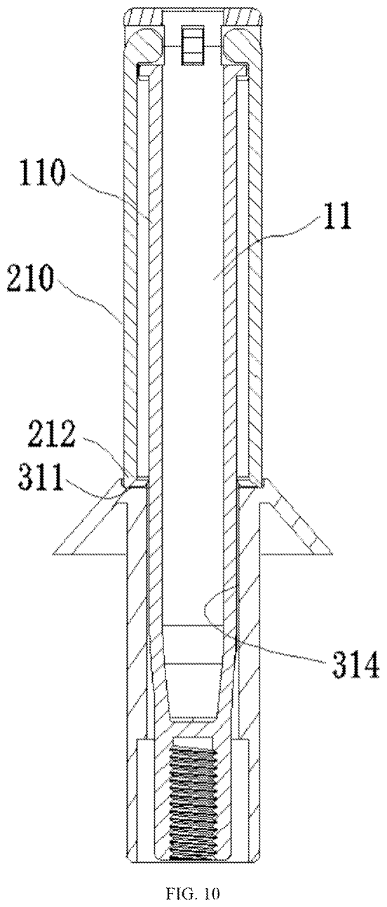

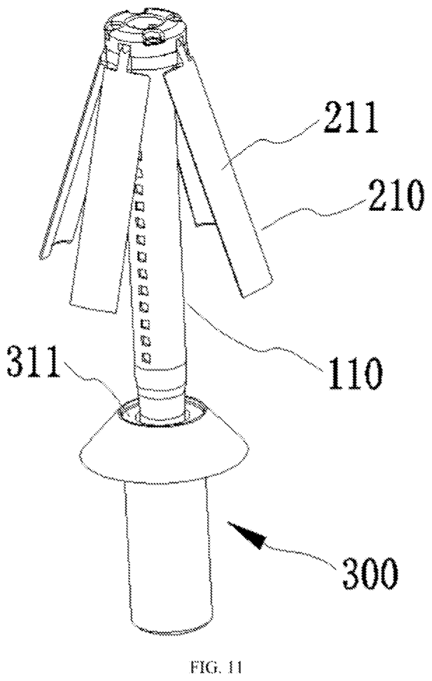

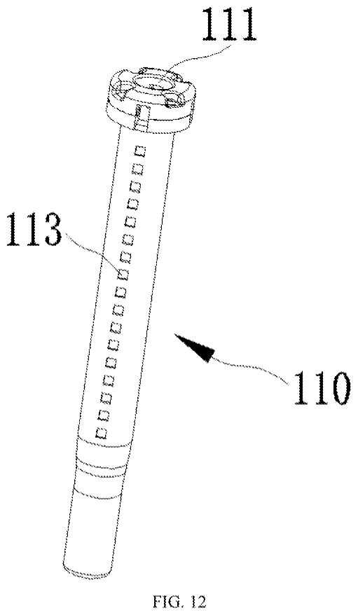

Referring to FIG. 4, the unlocking assisting member 130 is arranged on the support rod 110, which is arranged under the shaft base by a suitable distance, that is, arranged under the pivot shaft of each of the support member 210. The pivot shaft refers to a pivot shaft formed when the support member 210 is pivoted about the pivot shaft 201. Further, the unlocking assisting member 130 is protruded on a surface of the support rod 110, such that each of the support members 210 is fitted, at the lower end thereof, into the locking slot 311 and is thus locked by the locking slot. The unlocking assisting member 130 acts on the inner wall of the support member 210 to cause the inner wall to be slightly deformed. In this case, where the adjustment assembly 300 is operated to be displaced downward by a suitable distance, the lower end of each of the support members 210 is separated from the locking slot 311, and is pivoted to a smaller angle under the effect of the unlocking assisting member 130 such that the lower end of the support member 210 is slightly flared outward to form an unlocking initial state as illustrated in FIG. 6 and FIG. 7.

Apparently, since the lower end of each of the support members 210 is fitted with the guide surface 313 under the effect of the unlocking assisting member 130, the adjustment assembly 300 is further operated to be displaced upward, and thus a pivot angle of the support member 210 is adjusted, such that the support surface of the support member 210 satisfies a use requirement. Such a structural design plays a proactive role with respect to user operations.

Referring to FIG. 8, the treetop support is adjusted to thus use state in some occasions, such that the treetop support is fixed by the conical support plane formed by the outer surfaces of the support members 210. Nevertheless, an angle of conical surface of the conical support plane is not limited to the angle as illustrated in FIG. 8, but may be adjusted by the upward and downward displacements of the adjustment assembly 300 along the support rod 110.

In order that the treetop support achieves a good effect and a beautiful appearance both when being folded and unfolded, a cross section of each of the support members 210 is in a circular shape with a ¼ circumference, such that the treetop support is formed as a cylinder-like structure as illustrated in FIG. 1 and FIG. 2 to act as a treetop support capable of receiving or matching a fixing inner cavity in a cylindrical shape, a prismatic shape, or other shapes when not being used.

Nevertheless, the cross section of the support member 210 may also be in another shape or radian. For example, when a cross section of the support rod 110 is a square, the cross section of the support member 210 is a rectangle having a length equal to a length of each edge of the support rod 110. In this way, when each of the support members 210 is pivoted to be attached to the support rod 110, an integral structure in a cubic shaped is formed. In addition, the number of support rods 210 is not limited to four in the drawings, but may be an even greater or smaller number, for example, two, three, five, sixth, or even more.

Further, for better matching with the treetop decorative piece having a conical fixing cavity, in the treetop support, the pivot shaft 201 of each of the support members 210 is arranged to be proximal as much as possible to the top end of the support rod 110, such that the treetop support, when being unfolded, has a conical or cone-like support plane.

In some other embodiments, a lower end surface of the support member 210 is a beveled surface, and thus the lower end surface is better fitted with the guide surface 313 of the adjustment portion 310 during the adjustment.

In some other embodiments, the support rod 110 is hollowed out and formed as an inner cavity 11. The inner cavity 11 includes an upper cavity 111 such that the treetop decorative piece having a line-shape or rod-shape fixing connection portion is fitted into the upper cavity 111, and thus the treetop decorative piece 600 is fixed. In addition, the inner cavity 11 is preferably arranged to allow the upper and lower ends of the support rod 110 to pass through, such that a lower cavity 112 is formed at the lower end of the support rod 110. Where the inner cavity 11 is not arranged to allow the upper and lower ends of the support rod 110 to pass through, the upper cavity 111 is not communicated with the lower cavity 112.

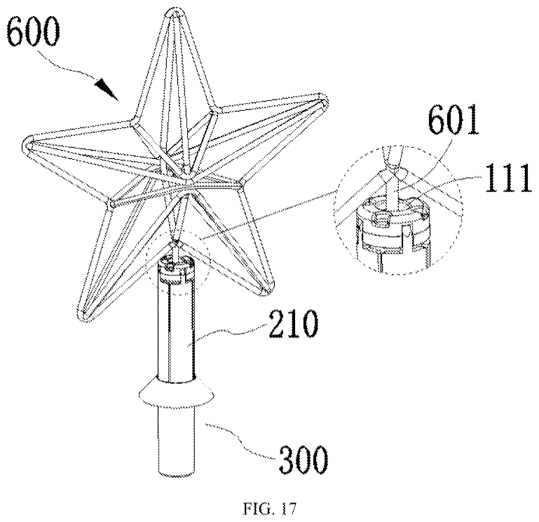

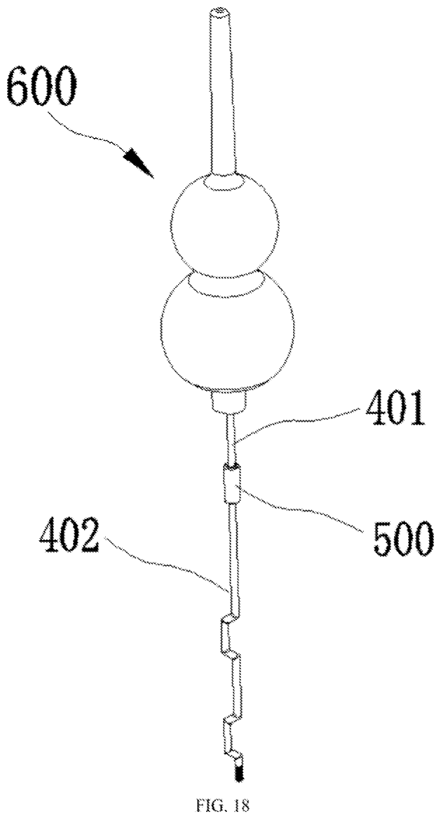

Referring to FIG. 17, a lower end of the treetop decorative piece 600 is provided with a rod-shape fixing connection portion 601 as a fixing portion of the treetop decorative piece 600. The treetop decorative piece is fitted into the upper cavity 111, and acts on, by a bottom end of the rod-shaped connection portion 601, a bottom of the upper cavity 111, or the treetop decorative piece 600 acts on the upper end of the support rod 110. In this way, the treetop decorative piece 600 is fixed.

Meanwhile, an inner wall of the inner cavity 11 at the lower end of the support rod 110 is further provided with female threads.

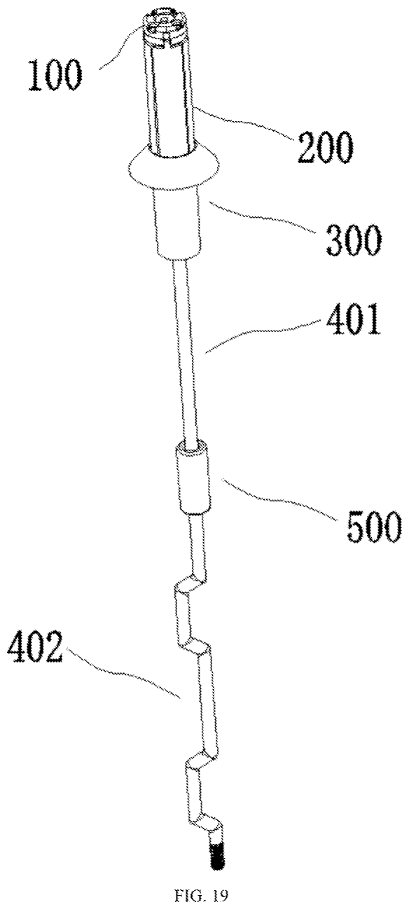

Referring to FIG. 19, in some other embodiments, the treetop support further includes a first rod 401, a second rod 402, and a connection member 500. An upper end of the first rod 401 is fitted into the lower cavity 112 at the lower end of the support rod 110. A lower end of the first rod 401 and an upper end of the second rod 402 are respectively fitted with an upper end and a lower end of the connection member 500.

For example, the inner wall of an inner cavity 11 at the lower end of the support rod 110, and the inner walls of the upper and lower ends of the connection member 500 are all provided with female threads, and the upper and lower ends of the first rod 401 and the upper end of the second rod 402 are correspondingly provided with male threads, such that these parts are fitted with each other by the corresponding thread structures. Nevertheless, besides thread engagement, other known fitting fashions are also available, for example, straight-rod interference fitting, which is not limited herein.

By the first rod 401, the second rod 402, and the connection member 500, the treetop support is fixed to the treetop of the Christmas tree.

In addition, with respect to a gourd-like treetop decorative piece, the decorative piece, due to the rod-like fixing connection portion, may be fixed to the treetop of the Christmas tree by the first rod 401, the second rod 402, and the connection member 500. That is, the support rod 101, the first rod 401, the second rod 402, and the connection member 500 may be fitted with each other by threads, or may be fitted with each other by insertion (during the insertion engagement, two adjacent parts are fitted with each preferably by interference fitting), such that these parts are connected to each other.

Referring to FIG. 18, the first rod 401, the connection member 500, and the second rod 402 are successively connected, the gourd-like treetop decorative piece 600 is sleeved onto the upper end of the first rod 401, and the second rod 402 is fixed to the treetop of the Christmas tree. In this way, the treetop decorative piece is fixed. Nevertheless, the gourd-like treetop decorative piece 600 as illustrated in the drawings is only exemplary for illustration purposes. Other treetop decorative pieces having a rod-like fixing connection portion may be likewise fixed by the above structure.

Further, although FIG. 13 to FIG. 18 respectively illustrate fitting states when the treetop support is applicable to different treetop decorative pieces, the shape of the treetop decorative piece matching with the treetop support is not limited to that illustrated in the drawings. In practice, treetop decorative pieces having any corresponding fixing connection portions may be fixed by the treetop support.

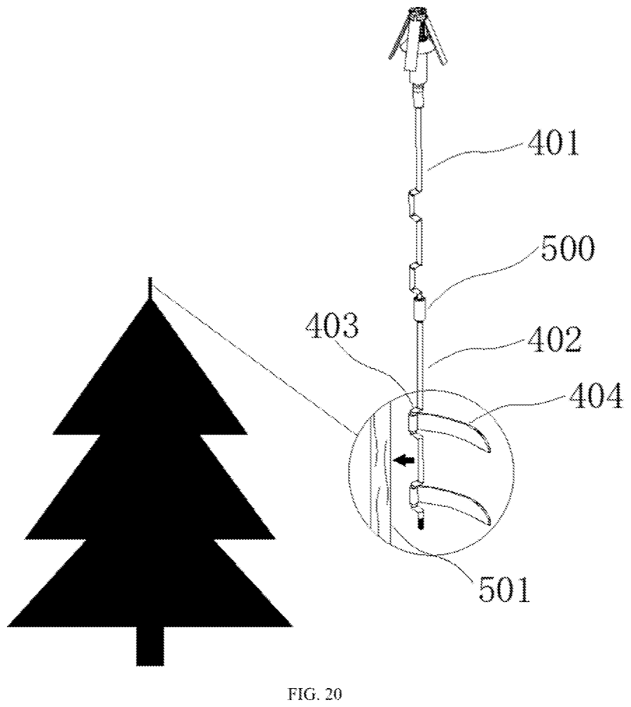

Referring to FIG. 20, the treetop support according to an embodiment of the present disclosure is bound and fixed to a treetop by a strap 404 at a strap fixing port 403 at the lower end of the second rod 402, such that the treetop support is fixed to the treetop of the Christmas tree. In addition, in this embodiment, the first rod 401 and the second rod 402 are two totally identical structures for ease of manufacturing, and the lower end of the second rod 402 is provided with the strap fixing port 403 for fitting of one end of the strap 404. Preferably, the strap 404 may be a strap having a hook and loop tape, wherein two side surfaces of the strap are respectively provided with loop and hook.

We claim:

1. A treetop support, applicable to a treetop of a Christmas tree to allow a treetop decorative piece to be fixed to the treetop of the Christmas tree by the treetop support; wherein the treetop support comprises a support body (100), and a support assembly (200) and an adjustment assembly (300) that are fitted on the support body; wherein
the support body (100) comprises a support rod (110), and the support assembly (200) comprises at least two support members (210), an upper end of each of the support members being pivotally fitted on an upper end of the support rod, an outer surface of each of the support members (210) being formed as a support surface (211), the support surfaces (211) being collectively formed as a cylindrical support surface or a prismatic surface of the support assembly (200); and
the adjustment assembly (300) is displaceably arranged along an extending direction of the support rod (110), and the adjustment assembly (300) comprises an adjustment portion (310), the adjustment portion (310) being fitted on a lower end or an inner wall of each of the support members (210).

2. The treetop support according to claim 1, wherein a top portion of the support rod (110) is provided with a shaft base fixing cover (120) connected to the support rod (110), wherein the shaft base fixing cover (120) and the support rod (110) are each provided with a half-shaft base (202), the two half shaft bases being fitted to each other to form a shaft base, an upper end of the support member being provided with a pivot shaft (201) fitted to the shaft base.

3. The treetop support according to claim 1, wherein an upper end of the adjustment portion (310) is provided with a locking slot (311), and the lower end of each of the support members (210) is locked in response to the support member (210) being fitted into the locking slot (311).

4. The treetop support according to claim 3, further comprising an unlocking assisting member (130) arranged on the support rod (110), wherein the unlocking assisting member (130) is arranged under a pivot shaft of each of the support members (210) and is protruded on a surface of the support rod (110).

5. The treetop support according to claim 4, wherein the unlocking assisting member (130) is arranged proximal to the upper end of the support rod (110).

6. The treetop support according to claim 3, wherein an outer wall of the support rod (110) and an inner wall of the cylindrical cavity (312) are respectively provided with threaded structures fittable with each other, such that the adjustment assembly (300) is displaced upward and downward or positioned by rotation with respect to the support rod (110).

7. The treetop support according to claim 4, wherein the support rod (110) is further provided with an inner cavity (11) formed by internal hollowing out of the support rod (110), wherein the inner cavity (11) comprises an upper cavity (111).

8. The treetop support according to claim 4, wherein a number of the support members (210) is two, three, four, five, or six, a lower end surface of the support member (210) is a beveled surface, a cross section of each of the support members (210) is in an arc shape, and the adjustment portion (310) is further provided with a guide surface (313), wherein the guide surface (313) is a conical surface or a curved surface.

9. A treetop support, applicable to a treetop of a Christmas tree to allow a treetop decorative piece to be fixed to the treetop of the Christmas tree by the treetop support; wherein the treetop support comprises a support body (100), and a support assembly (200) and an adjustment assembly (300) that are fitted on the support body; wherein
the support assembly (200) comprises a plurality of support members (210), each of the support members (210) being pivotably fitted on the support body (100), an outer surface of each of the support members (210) being formed as a support surface (211); and
the adjustment assembly (300) is displaceably arranged along an extending direction of the support body (100), and the adjustment assembly (300) is fitted on a lower end or an inner wall of each of the support members (210).

10. The treetop support according to claim 9, wherein an upper end of the adjustment portion (310) is provided with a locking slot (311), and the lower end of each of the support members (210) is fitted into the locking slot (311) to lock the support member (210).

11. The treetop support according to claim 9, wherein the support body (100) comprises a support rod (110); and the support member (210) and the support rod (110) are correspondingly provided with a pivot shaft (201) and a shaft base respectively.

12. The treetop support according to claim 11, further comprising an unlocking assisting member (130) arranged on the support rod (110), wherein the unlocking assisting member (130) is arranged under a pivot shaft of each of the support members (210) and is protruded on a surface of the support rod (110).

13. The treetop support according to claim 12, wherein the pivot shaft (201) or the shaft base is arranged on an upper end of each of the support members (210), and the unlocking assisting member (130) is arranged proximal to an upper end of the support rod (110);
an outer wall of the support rod (110) and an inner wall of the cylindrical cavity (312) are respectively provided with threaded structures fittable with each other, such that the adjustment assembly (300) is displaced upward and downward or positioned by rotation with respect to the support rod (110); or
the adjustment assembly (300) is freely displaceably fitted on the support rod (110) and is locked and positioned by a locking mechanism, the locking mechanism comprising a locking slot and a locking block respectively arranged on the support rod (110) and the adjustment assembly (300).

14. The treetop support according to claim 10, wherein the support body (100) is provided with an inner cavity (11) formed by internal hollowing out of the support body, wherein the inner cavity (11) is configured to allow upper and lower ends of the support rod (110) to pass through or not pass through, and an upper cavity (111) is formed on an upper end of the support body (100).

15. A treetop support, applicable to a treetop of a Christmas tree to allow a treetop decorative piece to be fixed to the treetop of the Christmas tree by the treetop support; wherein the treetop support comprises a support body (100), and a support assembly (200) and an adjustment assembly (300) that are fitted on the support body; wherein
the support assembly (200) comprises a plurality of support members (210), each of the support members (210) being pivotably fitted on the support body (100), an outer surface of each of the support members (210) being formed as a support surface (211); and the adjustment assembly (300) is displaceably arranged along an extending direction of the support body (100), and the adjustment assembly (300) is fitted on a lower end or an inner wall of each of the support members (210);
a lower end of the support body (100) is further provided with a lower cavity (112); and
the treetop support further comprises a first rod (401), a second rod (402), and a connection member (500), an upper end of the first rod being fitted with the lower cavity (112), a lower end of the first rod and an upper end of the second rod being respectively fitted with an upper end and a lower end of the connection member (500).

16. The treetop support according to claim 15, wherein an upper end of the adjustment portion (310) is provided with a locking slot (311), and the lower end of each of the support members (210) is fitted into the locking slot (311) to lock the support member (210).

17. The treetop support according to claim 15, wherein the support body (100) comprises a support rod (110); and the support member (210) and the support rod (110) are correspondingly provided with a pivot shaft (201) and a shaft base respectively; and
the treetop support further comprises an unlocking assisting member (130) arranged on the support rod (110), wherein the unlocking assisting member (130) is arranged under a pivot shaft of each of the support members (210) and is protruded on a surface of the support rod (110).

18. The treetop support according to claim 17, wherein the pivot shaft (201) or the shaft base is arranged on an upper end of each of the support members (210), and the unlocking assisting member (130) is arranged proximal to an upper end of the support rod (110);
an outer wall of the support rod (110) and an inner wall of the cylindrical cavity (312) are respectively provided with threaded structures fittable with each other, such that the adjustment assembly (300) is displaced upward and downward or positioned by rotation with respect to the support rod (110); or
the adjustment assembly (300) is freely displaceably fitted on the support rod (110) and is locked and positioned by a locking mechanism, the locking mechanism comprising a locking slot and a locking block respectively arranged on the support rod (110) and the adjustment assembly (300).

19. The treetop support according to claim 17, wherein the support body (100) is provided with an inner cavity (11) formed by internal hollowing out of the support body, wherein the inner cavity (11) is configured to allow upper and lower ends of the support rod (110) to pass through or not pass through, and an upper cavity (111) is formed on an upper end of the support body (100).

20. The treetop support according to claim 17, wherein an inner wall of an inner cavity (11) at a lower end of the support rod (110), and inner walls of upper and lower ends of the connection member (500) are all provided with female threads, and the upper and lower ends of the first rod (401) and the upper end of the second rod (402) are correspondingly provided with male threads;
the adjustment portion (310) is further provided with a guide surface (313), the guide surface (313) being a conical surface or a curved surface; and
each of the support members (210) is pivoted such that the support assembly (200) and the support body (100) are formed as a cylindrical or prismatic shape in response to the support assembly (200) being attached to the support body (100).
The present disclosure relates to the technical field of festival decoration products, and in particular, relates to a treetop support. The treetop support includes a support body, a support assembly, and an adjustment assembly. The support assembly includes a plurality of support members pivotably fitted on a support rod. Support surfaces of the support members are collectively formed as a support plane. The adjustment assembly is displaceably arranged along an extending direction of the support body. The adjustment assembly is fitted on a lower end or an inner wall of each of the support members, such that the support member is pivoted with respect to the support rod to adjust an angle of the support surface.
